(19) United States
(12) Patent Application Publication
(10) Pub. No.: US 2025/0260242 A1
(43) Pub. Date: Aug. 14, 2025

(54) POWER SUPPLY CIRCUIT FOR BALANCING AND ISOLATING BATTERIES

(71) Applicant: QUALCOMM Incorporated, San Diego, CA (US)

(72) Inventors: Yunsheng HUO, Sunnyvale, CA (US); Xinying DING, Cupertino, CA (US); Guoyong GUO, San Jose, CA (US); Joseph Dale RUTKOWSKI, Chandler, AZ (US); Xiangfei MA, San Diego, CA (US)

(21) Appl. No.: 18/913,648

(22) Filed: Oct. 11, 2024

Related U.S. Application Data
(60) Provisional application No. 63/552,456, filed on Feb. 12, 2024.

(51) Int. Cl. H02J 7/00

(52) U.S. Cl. CPC H02J 7/0019; H02J 7/007182; H02J 7/00308

(57) ABSTRACT

Techniques and apparatus for supplying power, including battery balancing and isolating. One example power supply circuit generally includes a first battery node for coupling to a first battery, a second battery node for coupling to a second battery, and a switch circuit coupled between the first battery node and the second battery node and disposed on a same integrated circuit (IC) die as the first battery node and the second battery node. The power supply circuit may be configured to balance the first battery and the second battery without a resistor (e.g., a resistor external to the IC die on which the power supply circuit resides).

### CROSS-REFERENCE TO RELATED APPLICATION(S)

The present application claims the benefit of and priority to U.S. Provisional Application No. 63/552,456, filed Feb. 12, 2024, which is expressly incorporated by reference herein in its entirety as if fully set forth below and for all applicable purposes.

### TECHNICAL FIELD

Certain aspects of the present disclosure generally relate to power supply circuits and, more particularly, to techniques and apparatus for balancing and isolating multiple independent batteries.

### BACKGROUND

A voltage regulator ideally provides a constant direct current (DC) output voltage regardless of changes in load current or input voltage. Voltage regulators may be classified as linear regulators or switching regulators. While linear regulators tend to be relatively compact, many applications may benefit from the increased efficiency of a switching regulator. A linear regulator may be implemented by a low-dropout (LDO) regulator, for example. A switching regulator (also known as a “switching converter” or “switcher”) may be implemented, for example, by a switched-mode power supply (SMPS), such as a buck converter, a boost converter, a buck-boost converter, or a charge pump.

For example, a buck converter is a type of SMPS typically comprising: (1) a high-side switch coupled between a relatively higher voltage rail and a switching node, (2) a low-side switch coupled between the switching node and a relatively lower voltage rail, (3) and an inductor coupled between the switching node and a load (e.g., represented by a shunt capacitive element). The high-side and low-side switches are typically implemented with transistors, although the low-side switch may alternatively be implemented with a diode.

Power management integrated circuits (power management ICs or PMICs) are used for managing the power scheme of a host system and may include and/or control one or more voltage regulators (e.g., buck converters or charge pumps). A PMIC may be used in battery-operated devices, such as mobile phones, tablets, laptops, wearables, etc., to control the flow and direction of electrical power in the devices. The PMIC may perform a variety of functions for the device such as DC-to-DC conversion (e.g., using a voltage regulator as described above), battery charging, power-source selection, voltage scaling, power sequencing, etc.

### SUMMARY

The systems, methods, and devices of the disclosure each have several aspects, no single one of which is solely responsible for its desirable attributes. Without limiting the scope of this disclosure as expressed by the claims that follow, some features are discussed briefly below. After considering this discussion, and particularly after reading the section entitled “Detailed Description,” one will understand how the features of this disclosure provide the advantages described herein.

Certain aspects of the present disclosure provide a power supply circuit. The power supply circuit generally includes a first battery node for coupling to a first battery, a second battery node for coupling to a second battery, and a switch circuit coupled between the first battery node and the second battery node and disposed on a same integrated circuit die as the first battery node and the second battery node.

Certain aspects of the present disclosure provide a power supply circuit. The power supply circuit generally includes a first battery node for coupling to a first battery, a second battery node for coupling to a second battery, and an adjustable resistive element coupled between the first battery node and the second battery node and on a same integrated circuit die as the first battery node and the second battery node.

Certain aspects of the present disclosure provide a device. The device generally includes a first battery coupled to a first battery node, a second battery coupled to a second battery node, and a switch circuit coupled between the first battery node and the second battery node and disposed on a same integrated circuit die as the first battery node and the second battery node

Certain aspects of the present disclosure provide a device. The device generally includes a first battery coupled to a first battery node, a second battery coupled to a second battery node, and a switch circuit coupled between the first battery node and the second battery node. The switch circuit is generally configured to balance, during a first mode in which the switch circuit is configured to be closed, a voltage of the first battery and a voltage of the second battery and isolate, during a second mode in which the switch circuit is configured to be open, the first battery from the second battery.

Certain aspects of the present disclosure are directed to a method of supplying power. The method generally includes balancing, during a first mode, a voltage of a first battery coupled to a first battery node and a voltage of a second battery coupled to a second battery node by closing a switch circuit, and isolating, during a second mode, the first battery from the second battery by opening the switch circuit. The switch circuit is on a same integrated circuit die as the first battery node and the second battery node.

Certain aspects of the present disclosure provide an integrated circuit (e.g., a power management integrated circuit (PMIC)) comprising at least a portion of any of the power supply circuits described above.

Certain aspects of the present disclosure provide a battery charging circuit comprising any of the power supply circuits described above.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of an example device comprising a power management system that includes a power management integrated circuit (PMIC) and a battery charging circuit, in which aspects of the present disclosure may be practiced.

FIG. 2 is a circuit diagram of an example power supply circuit, in accordance with certain aspects of the present disclosure.

FIG. 3 is a circuit diagram of an example power supply circuit capable of balancing and isolating multiple independent batteries that includes a switching regulator and an example switch circuit, in accordance with certain aspects of the present disclosure.

FIG. 4 is a flow diagram of example operations for supplying power, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure provide techniques and apparatus for balancing and isolating multiple independent batteries using a power supply circuit. Such a power supply circuit may be capable of selectively balancing a voltage of a first battery and a voltage of a second battery (e.g., in a first mode of device operation) and isolating the first battery from the second battery (e.g., in a second mode of device operation). In certain aspects, the power supply circuit may include a switch circuit for connecting (e.g., to enable balancing) and disconnecting (e.g., to enable isolating) the multiple independent batteries. The power supply circuit may be configured to balance the first battery and the second battery without a resistor (e.g., a resistor external to the IC die on which the power supply circuit resides).

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Device

It should be understood that aspects of the present disclosure may be used in a variety of applications. Although the present disclosure is not limited in this respect, the circuits disclosed herein may be used in any of various suitable apparatus, such as in the power supply, battery charging circuit, or power management circuit of a communication system, a video codec, audio equipment such as music players and microphones, a television, camera equipment, and test equipment such as an oscilloscope. Communication systems intended to be included within the scope of the present disclosure include, by way of example only, cellular radiotelephone communication systems, satellite communication systems, two-way radio communication systems, one-way pagers, two-way pagers, personal communication systems (PCS), personal digital assistants (PDAs), and the like.

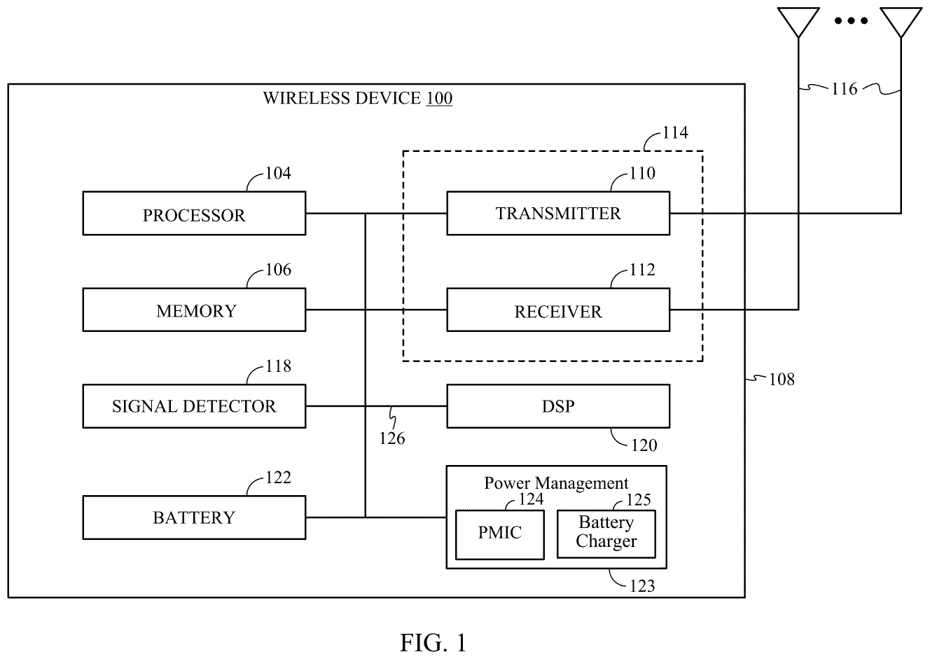

FIG. 1 illustrates an example device 100 in which aspects of the present disclosure may be implemented. The device 100 may be a battery-operated device such as a cellular phone, a PDA, a handheld device, a wireless device, a laptop computer, a tablet, a smartphone, an Internet of things (IoT) device, a wearable device, etc. For certain aspects, the device 100 may be a foldable device (e.g., a flip phone).

The device 100 may include a processor 104 that controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106.

In certain aspects, the device 100 may also include a transmitter 110 and/or a receiver 112 to allow transmission and reception of data between the device 100 and a remote location. For certain aspects, the transmitter 110 and receiver 112 may be combined into a transceiver 114. One or more antennas 116 may be attached or otherwise coupled to a housing 108 of the device 100 and electrically connected to the transceiver 114. The device 100 may also include (not shown) multiple transmitters, multiple receivers, and/or multiple transceivers.

The device 100 may also include a signal detector 118 that may be used in an effort to detect and quantify the level of signals received by the transceiver 114. The signal detector 118 may detect such signal parameters as total energy, energy per subcarrier per symbol, and power spectral density, among others. The device 100 may also include a digital signal processor (DSP) 120 for use in processing signals.

The device 100 may further include a battery 122, which may be used to power the various components of the device 100 (e.g., when another power source—such as a wall adapter or a wireless power charger—is unavailable). The battery 122 may comprise a single cell or multiple cells connected in series and/or in parallel. The device 100 may further include additional independent batteries (not shown). Each of the additional independent batteries may comprise a single cell or multiple cells connected in series and/or in parallel.

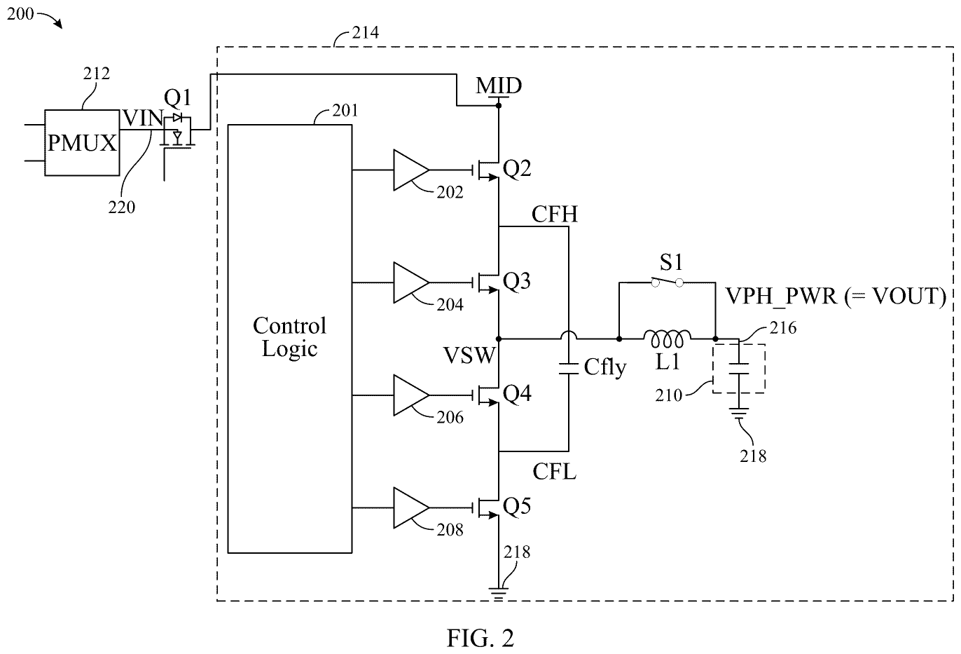

The device 100 may also include a power management system 123 for managing the power from the battery 122 (or batteries), a wall adapter, and/or a wireless power charger to the various components of the device 100. The power management system 123 may perform a variety of functions for the device such as DC-to-DC conversion, battery charging, power-source selection, voltage scaling, power sequencing, source mode power, etc. In certain aspects, the power management system 123 may include a power management integrated circuit (power management IC or PMIC) 124 and one or more power supply circuits, such as a battery charger 125, which may be controlled by the PMIC or logic associated with the battery charger, for example. For certain aspects, at least a portion of one or more of the power supply circuits (e.g., at least a portion of the battery charger 125) may be integrated in the PMIC 124. The PMIC 124 and/or the one or more power supply circuits may include at least a portion of a switched-mode power supply (SMPS) circuit, which may be implemented by any of various suitable switched-mode power supply circuit topologies, such as a two-level buck converter, a three-level buck converter, a charge pump, or an adaptive combination power supply circuit (e.g., the SMPS circuit 214 of FIG. 2), which can switch between operating in a buck converter mode and a charge pump mode, as described below.

The various components of the device 100 may be coupled together by a bus system 126, which may include a power bus, a control signal bus, and/or a status signal bus in addition to a data bus. Additionally or alternatively, various combinations of the components of the device 100 may be coupled together by one or more other suitable techniques.

### Example Power Supply Circuits and Operation

As described above, the PMIC 124 and/or the one or more power supply circuits (e.g., battery charger 125) may include at least a portion of an SMPS circuit (e.g., a buck converter, a charge pump converter, or an adaptive combination power supply circuit capable of switching therebetween), which may be a single-phase or multi-phase converter. In the case of an adaptive combination power supply circuit, both converter modes may be single-phase, both converter modes may be multi-phase, one converter mode may be single-phase while the other converter mode is multi-phase or capable of changing between single-phase and multi-phase, or one converter mode may be multi-phase while the other converter mode is capable of changing between single-phase and multi-phase.

FIG. 2 is a circuit diagram of an example power supply circuit 200, which may be used to charge one or more batteries. As illustrated, the power supply circuit 200 includes a power multiplexer 212 (labeled “PMUX”), a reverse-current-blocking transistor Q1 (which may also be referred to as an overvoltage protection (OVP) field-effect transistor (FET) or an input FET), and an SMPS circuit 214 (e.g., an adaptive SMPS circuit).

The power multiplexer 212 may be configured to select between receiving power from, for example, (i) a Universal Serial Bus (USB) port for connecting to a wall adapter and (ii) a wireless power port (both not shown). The power multiplexer 212 may be implemented as a single-pole, double-throw (SPDT) switch by two OVP FETs, and in this case, transistor Q1 may be eliminated.

In certain aspects, the output of the power multiplexer 212 may be coupled to an input voltage node 220 (labeled “VIN”). The input voltage node 220 may be coupled to a source of the transistor Q1, and a drain of the transistor Q1 may be coupled to a voltage node (labeled “MID”) of the SMPS circuit 214. The MID voltage node may serve as the power supply rail of the SMPS circuit 214, and in some cases, may alternatively be considered as an input node of the SMPS circuit. In some cases, the power multiplexer 212 and/or transistor Q1 may be removed.

For certain aspects, the SMPS circuit 214 may have a two-level buck converter topology. For other aspects, the SMPS circuit 214 may have a single-phase three-level buck converter topology (as illustrated in the power supply circuit 200 of FIG. 2), and may include a second transistor Q2, a third transistor Q3, a fourth transistor Q4, a fifth transistor Q5, a flying capacitive element Cfly, an inductive element L1, and a load 210, which is represented here by a capacitor. For other aspects, the SMPS circuit 214 may have a dual-phase three-level buck converter topology. To realize an adaptive SMPS circuit, a switch S1 may be added across the inductive element L1 of the three-level buck converter topology. With the switch S1 closed, the adaptive SMPS circuit may function as a single-phase divide-by-two (Div2) charge pump converter, as further described below. In certain aspects, switch S1 may be implemented by two back-to-back transistors.

Transistor Q3 may be coupled to transistor Q2 via a first node (labeled “CFH” for flying capacitor high node), transistor Q4 may be coupled to transistor Q3 via a second node (labeled “VSW” for voltage switching node), and transistor Q5 may be coupled to transistor Q4 via a third node (labeled “CFL” for flying capacitor low node). For certain aspects, the transistors Q2-Q5 may be implemented as n-type metal-oxide-semiconductor (NMOS) transistors, as illustrated in FIG. 2. In this case, the drain of transistor Q3 may be coupled to the source of transistor Q2, the drain of transistor Q4 may be coupled to the source of transistor Q3, and the drain of transistor Q5 may be coupled to the source of transistor Q4. The source of transistor Q5 may be coupled to a reference potential node 218 (e.g., electric ground) for the power supply circuit 200. The flying capacitive element Cfly may have a first terminal coupled to the first node and a second terminal coupled to the third node. The inductive element L1 may have a first terminal coupled to the second node and a second terminal coupled to an output voltage node 216 (labeled “VOUT,” which may also be referred to as “VPH_PWR” or “VPH”) and the load 210.

Control logic 201 may control operation of the SMPS circuit 214 and other aspects of the power supply circuit 200. For example, the control logic 201 may control operation of the transistors Q2-Q5 via output signals to the inputs of respective gate drivers 202, 204, 206, and 208. The outputs of the gate drivers 202, 204, 206, and 208 are coupled to respective gates of transistors Q2-Q5. During operation of the adaptive SMPS circuit (or of a three-level buck converter), the control logic 201 may cycle through four different phases, which may differ depending on whether the duty cycle is less than 50% or greater than 50%.

Operation of the adaptive SMPS circuit with a duty cycle of less than 50% is described first. In a first phase (referred to as a “charging phase”), transistors Q2 and Q4 are activated, and transistors Q3 and Q5 are deactivated, to charge the flying capacitive element Cfly and to energize the inductive element L1. In a second phase (called a “holding phase”), transistor Q2 is deactivated, and transistor Q5 is activated, such that the VSW node is coupled to the reference potential node, the flying capacitive element Cfly is disconnected (e.g., one of the Cfly terminals is floating), and the inductive element L1 is deenergized. In a third phase (referred to as a “discharging phase”), transistors Q3 and Q5 are activated, and transistor Q4 is deactivated, to discharge the flying capacitive element Cfly and to energize the inductive element L1. In a fourth phase (also referred to as a “holding phase”), transistor Q4 is activated, and transistor Q3 is deactivated, such that the flying capacitive element Cfly is disconnected and the inductive element L1 is deenergized.

Operation of the adaptive SMPS circuit with a duty cycle greater than 50% is similar in the first and third phases, with the same transistor configurations. However, in the second phase (called a “holding phase”) following the first phase, transistor Q4 is deactivated, and transistor Q3 is activated, such that the VSW node is coupled to the MID node, the flying capacitive element Cfly is disconnected, and the inductive element L1 is energized. Similarly in the fourth phase (also referred to as a “holding phase”) with a duty cycle greater than 50%, transistor Q2 is activated, and transistor Q5 is deactivated, such that the flying capacitive element Cfly is disconnected and the inductive element L1 is energized.

Furthermore, the control logic 201 may have a control signal (not shown in FIG. 2) configured to control operation of switch S1 and selectively enable divide-by-two (Div2) charge pump operation. For certain aspects, when this control signal is logic low, switch S1 is open, and the power supply circuit 200 operates as a three-level buck converter using the inductive element L1. When this control signal is logic high for certain aspects, switch S1 is closed, thereby shorting across the inductive element L1 and effectively removing the inductive element L1 from the circuit, such that the adaptive SMPS circuit operates as a Div2 charge pump. The control logic 201 may be configured to automatically control operation of switch S1 (e.g., through the logic level of the control signal) based on an output current (also referred to as a “load current”) and/or an input current for the adaptive SMPS circuit.

### Example Power Supply Circuit for Multi-Battery Balancing and Isolating

Many portable devices (e.g., foldable and flip phones and Internet of things (IoT) devices) may utilize multiple independent batteries. In some cases, the portable devices may include an external (e.g., off-chip) resistor to connect and ensure the balance of the multiple independent batteries during shipping (e.g., when the device is shut down). However, there may be no way to control the resistor to selectively connect and disconnect the batteries.

Certain aspects of the present disclosure provide techniques and apparatus for selectively connecting and disconnecting multiple independent batteries using a power supply circuit that includes a switch circuit. In certain aspects, the switch circuit may be effectively implemented as a switch coupled in series with a resistive element or as an adjustable resistive element that can effectively achieve an open-circuit condition (or at least a high-impedance condition). The switch circuit may be implemented in the same integrated circuit (IC) die as the power supply circuit and may be controlled to selectively connect and disconnect the batteries by controlling the impedance between the batteries. In this manner, the power supply circuit may balance and isolate the batteries without the use of a resistor (e.g., an external resistor).

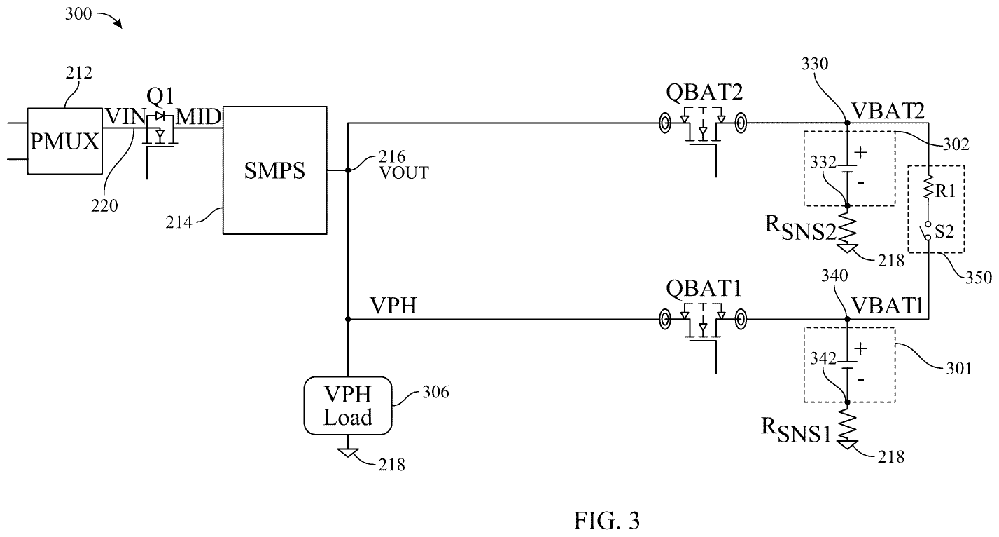

FIG. 3 is a circuit diagram of an example power supply circuit 300 capable of balancing and isolating multiple independent batteries using a switch circuit 350, in accordance with certain aspects of the present disclosure. For certain aspects, the power supply circuit 300 may include the power multiplexer 212, the transistor Q1, and a switching regulator (e.g., the SMPS circuit 214, as illustrated). The power supply circuit 300 may also include a load 306 (e.g., labeled “VPH Load”), a first switch (e.g., implemented by one or more transistors QBAT1), a second switch (e.g., implemented by one or more transistors QBAT2), a first battery 301 (BAT1), a second battery 302 (BAT2), and the switch circuit 350. For certain aspects, the power supply circuit may also include a first sense resistive element R_{SNS1} and/or a second sense resistive element R_{SNS2}. The batteries 301, 302 may be external to an IC (e.g., a PMIC), whereas at least a portion of the switching regulator, the switches (implemented by transistors QBAT1 and QBAT2), and the switch circuit 350 may be internal to the IC. The sense resistive elements R_{SNS1} and R_{SNS2} may be internal or external to the IC, or one sense resistive element may be internal while the other is external. For certain aspects, either or both of the sense resistive elements R_{SNS1} and R_{SNS2} may be eliminated, and the on-resistance(s) of the corresponding transistors QBAT1 and/or QBAT2 may be used as current-sensing resistor(s).

The load 306 may be analogous to the load 210 of FIG. 2. The load 306 may represent one or more circuits of a device (e.g., the device 100 of FIG. 1) that are powered internally by the switching regulator (e.g., with power supply rail VPH=VOUT) (e.g., when an external power source is provided to the power multiplexer 212) or by the batteries 301, 302 (e.g., when no external power source is available). The load 306 may be coupled (in shunt) to the reference potential node 218.

In certain aspects, the first battery 301 and/or the second battery 302 may represent a single-cell (1S) battery, a two-cell-in-series (2S) battery, or more than two stacked cells in a battery (e.g., a multi-cell-in series battery). The charging architecture illustrated in FIG. 3 represents a 1S2P configuration. The first battery 301 and the second battery 302 may be symmetrical batteries, having the same capacity (and size). The power supply circuit 300 may be included in a device that is foldable, which may include a first portion coupled to a second portion by a hinge. In this example, the first portion of the foldable device may include the first battery 301, and the second portion of the foldable device may include the second battery 302. In some cases, the first battery 301 may be the same battery type as the second battery 302, whereas in other cases, the first battery 301 and the second battery 302 may be different battery types.

In certain aspects, the output voltage node 216 of the SMPS circuit 214 may be coupled to transistor(s) QBAT1, transistor(s) QBAT2, and the load 306. In certain aspects, one or more of transistors QBAT1 and QBAT2 may be bidirectional switches, each implemented with one or more transistors. In some cases, transistor(s) QBAT1 and/or QBAT2 may be implemented by back-to-back transistors or a body-switchable transistor, for example. The gates of the QBAT1 and QBAT2 transistors may be driven by logic circuitry (e.g., the control logic 201 of FIG. 2 or other logic not shown in FIG. 3).

In certain aspects, transistor(s) QBAT1 may be coupled to the first battery 301 via a first battery node 340 (labeled “VBAT1”), and transistor(s) QBAT2 may be coupled to the second battery 302 via a second battery node 330 (labeled “VBAT2”). The first battery 301 may be coupled to the first sense resistive element R_{SNS1} via another first battery node 342 (e.g., coupled to the negative terminal of the first battery 301), and the second battery 302 may be coupled to the second sense resistive element R_{SNS2} via another second battery node 332 (e.g., coupled to the negative terminal of the second battery 302). The first and second sense resistive elements R_{SNS1} and R_{SNS2} may function as sensing resistors to measure the current through the first battery 301 and the second battery 302, respectively.

When the batteries 301, 302 are external to an IC with other circuitry of the power supply circuit 300, the IC may include a positive first battery port (e.g., a pin) coupled to the first battery node 340 and to the positive terminal of the first battery 301. In some cases, the IC may include a negative first battery port coupled to the other first battery node 342, to the first sense resistive element R_{SNS1}, and to the negative terminal of the first battery 301. Additionally or alternatively, the IC may include a positive second battery port coupled to the second battery node 330 and to the positive terminal of the second battery 302. In some cases, the IC may include a negative second battery port coupled to the other second battery node 332, to the sense resistive element R_{SNS2}, and to the negative terminal of the second battery 302. The sense resistive elements R_{SNS1} and R_{SNS2} may be coupled to the reference potential node 218.

In certain aspects, the positive terminals of the first battery 301 and the second battery 302 may be coupled together via the switch circuit 350, as shown. The switch circuit 350 may effectively include a resistive element R1 coupled in series with a switch S2, between the first battery node 340 and the second battery node 330. The resistive element R1 may have an adjustable resistance in some cases. In other aspects, the switch circuit 350 may be implemented with an adjustable resistance or impedance, and/or may be referred to as an adjustable resistive element or an adjustable impedance element. In certain aspects, the switch circuit 350 may be implemented on a same IC die as the first battery node 340 and the second battery node 330. The switch circuit 350 may be used to selectively balance and isolate batteries 301, 302, as described below.

In this manner, the switch circuit 350 may be configured to selectively couple the first battery node 340 to the second battery node 330 through a resistance (e.g., to balance the first battery 301 and the second battery 302), and to decouple the first battery node 340 and the second battery node 330 (e.g., to isolate the first battery 301 and the second battery 302).

### Example Battery Balancing and Isolating Operations

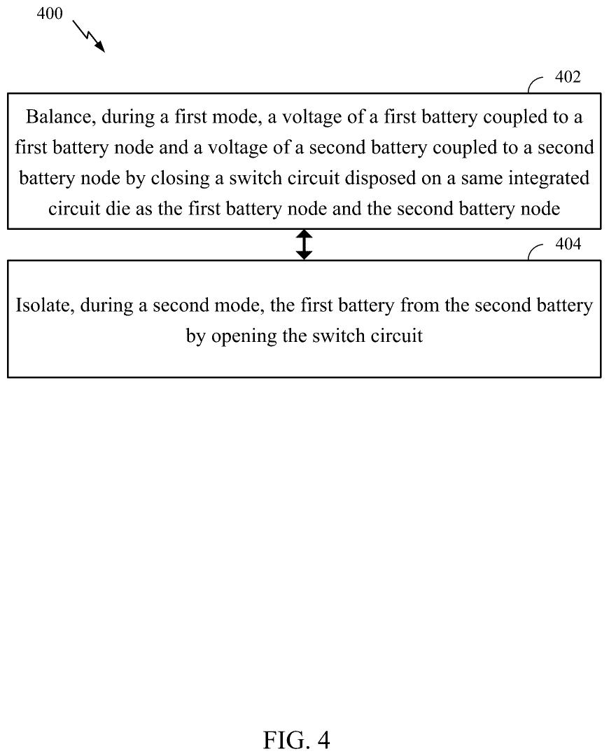

FIG. 4 is a flow diagram of example operations 400 for supplying power, in accordance with certain aspects of the present disclosure. The operations 400 may be performed by a power supply circuit (e.g., the power supply circuit 300 of FIG. 3) that includes a switch circuit (e.g., the switch circuit 350 of FIG. 3 or an adjustable resistive element).

The operations 400 may include, at block 402, balancing, during a first mode (e.g., a ship mode or a shutdown mode), a voltage of a first battery (e.g., first battery 301) coupled to a first battery node (e.g., first battery node 340) and a voltage of a second battery (e.g., second battery 302) coupled to a second battery node (e.g., second battery node 330) by closing a switch circuit (e.g., switch circuit 350). In some cases, the first battery may be the same battery type as the second battery, whereas in other cases, the first and second batteries may be different battery types.

In some examples, block 402 may involve balancing, during a shutdown mode, the voltage of the first battery and the voltage of the second battery by coupling (e.g., using the switch circuit) the first battery node to the second battery node while one of a first switch (e.g., transistor QBAT1) and a second switch (e.g., transistor QBAT2) is closed (e.g., to provide power to at least some circuits, such as a portion of load 306) and the other is open. In this manner, increased power savings (i.e., decreased power consumption) may be achieved during the shutdown mode (compared to having both the first switch and the second switch closed during the shutdown mode).

The operations 400 may include, at block 404, isolating, during a second mode (e.g., a normal operating mode), the first battery from the second battery by opening the switch circuit. By isolating the first battery from the second battery, the controlling of the charging and discharging of the batteries may be implemented separately. The isolation of the first battery and the second battery may also help enable more accurate battery voltage sensing and better battery control.

The switch circuit is on a same integrated circuit die as the first battery node and the second battery node. For example, the switch circuit may comprise a switch coupled in series with a resistive element (e.g., one or more resistors, which may, in some cases, be adjustable) or an adjustable resistive element capable of presenting a relatively high resistance for isolating and a relatively low resistance for balancing.

In some cases, the power supply circuit may perform block 402 before block 404. In other cases, the power supply circuit may perform block 404 before block 402. That is, the order of coupling the first battery and the second battery (e.g., to enable the balancing at block 402) and decoupling the first battery and the second battery (e.g., to enable the isolating at block 404) is flexible. The operations 400 may also be repeated.

According to certain aspects, the first mode may be a ship mode or a shutdown mode. For certain aspects, the second mode may be a mission mode (e.g., a normal operation mode in which the first battery and/or the second battery supply power to a portable device or in which the first battery and/or the second battery are charged by from an external power source provided to the portable device).

### Example Aspects

In addition to the various aspects described above, specific combinations of aspects are within the scope of the disclosure, some of which are detailed below:

Aspect 1: A power supply circuit comprising: a first battery node for coupling to a first battery; a second battery node for coupling to a second battery; and a switch circuit coupled between the first battery node and the second battery node and disposed on a same integrated circuit die as the first battery node and the second battery node.

Aspect 2: The power supply circuit of Aspect 1, wherein the switch circuit comprises a switch coupled in series with a resistive element.

Aspect 3: The power supply circuit of Aspect 2, wherein the resistive element comprises an adjustable resistive element.

Aspect 4: The power supply circuit of Aspect 1, wherein the switch circuit comprises an adjustable resistive element.

Aspect 5: The power supply circuit of Aspect 4, wherein the adjustable resistive element is configurable to have a relatively low resistance for balancing a voltage of the first battery and a voltage of the second battery and is configurable to have a relatively high resistance for effectively isolating the first battery from the second battery.

Aspect 6: A device comprising: a first battery coupled to a first battery node; a second battery coupled to a second battery node; and a switch circuit coupled between the first battery node and the second battery node and disposed on a same integrated circuit die as the first battery node and the second battery node.

Aspect 7: The device of Aspect 6, wherein the switch circuit comprises a switch coupled in series with a resistive element.

Aspect 8: The device of Aspect 7, wherein the resistive element comprises an adjustable resistive element.

Aspect 9: The device of Aspect 6, wherein the switch circuit comprises an adjustable resistive element.

Aspect 10: The device of Aspect 9, wherein the adjustable resistive element is configurable to have a relatively low resistance for balancing a voltage of the first battery and a voltage of the second battery and is configurable to have a relatively high resistance for isolating the first battery from the second battery.

Aspect 11: The device according to any of Aspects 6-10, wherein the switch circuit is configured to: balance, during a first mode in which the switch circuit is configured to be closed, a voltage of the first battery and a voltage of the second battery; and isolate, during a second mode in which the switch circuit is configured to be open, the first battery from the second battery.

Aspect 12: A method of supplying power, the method comprising: balancing, during a first mode, a voltage of a first battery coupled to a first battery node and a voltage of a second battery coupled to a second battery node by closing a switch circuit disposed on a same integrated circuit die as the first battery node and the second battery node; and isolating, during a second mode, the first battery from the second battery by opening the switch circuit.

Aspect 13: The method of Aspect 12, wherein the first mode comprises a ship mode or a shutdown mode of a device comprising the first battery, the second battery, and the integrated circuit die.

Aspect 14: The method of Aspect 13, wherein the second mode comprises a mission mode of the device.

Aspect 15: The method according to any of Aspects 12-14, wherein the switch circuit comprises a switch coupled in series with a resistive element.

Aspect 16: The method of Aspect 15, wherein the resistive element comprises an adjustable resistive element.

Aspect 17: The method according to any of Aspects 12-14, wherein the switch circuit comprises an adjustable resistive element.

Aspect 18: The method of Aspect 17, wherein the adjustable resistive element presents a relatively low resistance for balancing the voltage of the first battery and the voltage of the second battery and presents a relatively high resistance for isolating the first battery from the second battery.

### Additional Considerations

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A power supply circuit comprising:
a first battery node for coupling to a first battery;
a second battery node for coupling to a second battery; and
a switch circuit coupled between the first battery node and the second battery node and disposed on a same integrated circuit die as the first battery node and the second battery node.

2. The power supply circuit of claim 1, wherein the switch circuit comprises a switch coupled in series with a resistive element.

3. The power supply circuit of claim 2, wherein the resistive element comprises an adjustable resistive element.

4. The power supply circuit of claim 1, wherein the switch circuit comprises an adjustable resistive element.

5. The power supply circuit of claim 4, wherein the adjustable resistive element is configurable to have a relatively low resistance for balancing a voltage of the first battery and a voltage of the second battery and is configurable to have a relatively high resistance for effectively isolating the first battery from the second battery.

6. A device comprising:
a first battery coupled to a first battery node;
a second battery coupled to a second battery node; and
a switch circuit coupled between the first battery node and the second battery node and disposed on a same integrated circuit die as the first battery node and the second battery node.

7. The device of claim 6, wherein the switch circuit comprises a switch coupled in series with a resistive element.

8. The device of claim 7, wherein the resistive element comprises an adjustable resistive element.

9. The device of claim 6, wherein the switch circuit comprises an adjustable resistive element.

10. The device of claim 9, wherein the adjustable resistive element is configurable to have a relatively low resistance for balancing a voltage of the first battery and a voltage of the second battery and is configurable to have a relatively high resistance for isolating the first battery from the second battery.

11. The device of claim 6, wherein the switch circuit is configured to:
balance, during a first mode in which the switch circuit is configured to be closed, a voltage of the first battery and a voltage of the second battery; and
isolate, during a second mode in which the switch circuit is configured to be open, the first battery from the second battery.

12. A method of supplying power, the method comprising:
balancing, during a first mode, a voltage of a first battery coupled to a first battery node and a voltage of a second battery coupled to a second battery node by closing a switch circuit disposed on a same integrated circuit die as the first battery node and the second battery node; and
isolating, during a second mode, the first battery from the second battery by opening the switch circuit.

13. The method of claim 12, wherein the first mode comprises a ship mode or a shutdown mode of a device comprising the first battery, the second battery, and the integrated circuit die.

14. The method of claim 13, wherein the second mode comprises a mission mode of the device.

15. The method of claim 12, wherein the switch circuit comprises a switch coupled in series with a resistive element.

16. The method of claim 15, wherein the resistive element comprises an adjustable resistive element.

17. The method of claim 12, wherein the switch circuit comprises an adjustable resistive element.

18. The method of claim 17, wherein the adjustable resistive element presents a relatively low resistance for balancing the voltage of the first battery and the voltage of the second battery and presents a relatively high resistance for isolating the first battery from the second battery.
